(19) United States
(12) Patent Application Publication
(10) Pub. No.: US 2008/0100002 A1
(43) Pub. Date: May 1, 2008

(54) Cylinder apparatus

(76) Inventors: Kouji Minamino, Toyota-shi (JP); Shinichi Kagawa, Yokohama-shi (JP); Kazumasa Nakagawa, Yokohama-shi (JP); Yuusuke Maegawa, Berea, KY (US)

Correspondence Address: WENDEROTH, LIND & PONACK, L.L.P., 2033 K STREET N. W., SUITE 800, WASHINGTON, DC, 20006-1021, US

(21) Appl. No.: 11/902,328

(22) Filed: Sep. 20, 2007

(30) Foreign Application Priority Data
Oct. 31, 2006 (JP) 296844/2006

(51) Int. Cl. F02F 5/00

(52) U.S. Cl. 277/456

(57) ABSTRACT

A cylinder apparatus includes a cylinder having a hydraulic fluid sealed therein. A piston rod is connected at one end thereof to a piston slidably fitted in the cylinder. The other end of the piston rod extends to the outside of the cylinder through a seal device provided at the opening end of the cylinder. The seal device has a rod seal and a backup mechanism that presses the rod seal against the piston rod. The backup mechanism has a ring-shaped resilient member provided on the upper surface of a ring-shaped support plate clamped between a rod guide and a seal cap. The ring-shaped resilient member is elastically deformed by an annular tapered wall formed on the seal cap, thereby applying a backup force to the rod seal. Thus, the force with which the rod seal is pressed against the piston rod is kept substantially constant.

### BACKGROUND OF THE INVENTION

The present invention relates to a cylinder apparatus installed in a suspension system of an automobile, for example.

Examples of cylinder apparatus used in suspension systems of automobiles include a hydraulic cylinder apparatus for vehicle height control and a hydraulic shock-absorbing damper. FIG. 4 shows the structure of an essential part of a hydraulic cylinder apparatus for vehicle height control. The hydraulic cylinder apparatus includes a cylinder 1 having a hydraulic fluid sealed therein. A piston rod 2 is connected at one end thereof to a piston (not shown) slidably fitted in the cylinder 1. The other end of the piston rod 2 extends to the outside of the cylinder 1 through a seal device 3 provided at an opening end of the cylinder 1. The seal device 3 includes a seal block 4 having a bore for receiving the piston rod 2 and closing the opening end of the cylinder 1. The seal device 3 further includes a double seal 7 comprising a rod seal 5 provided in sliding contact with the piston rod 2 and an O-ring (backup mechanism) 6 that presses the rod seal 5 against the piston rod 2. Further, the seal device 3 includes an oil seal 8. The cylinder 1 is housed in an outer tube 9, one end of which is closed. The space between the cylinder 1 and the outer tube 9 is provided as an annular chamber 10 for storing hydraulic fluid flowing out of the cylinder 1 into the seal block 4.

The seal block 4 has a split structure comprising a rod guide 11 fitted to the cylinder 1 to slidably guide the piston rod 2, a seal cap 12 fitted to the rod guide 11 with the outer periphery thereof placed in close contact with the outer tube 9, and a lock ring 13 thread-engaged with the outer tube 9 to hold the seal cap 12 and the rod guide 11 from above. The double seal 7 is disposed between the rod guide 11 and the seal cap 12. For the lock ring 13, the oil seal 8 is provided. Between the rod guide 11 and the seal cap 12, a check valve 14 is provided to allow only the flow of hydraulic fluid from the cylinder 1 into the annular chamber 10. Between the seal cap 12 and the lock ring 13, a seal member 15 is provided to cut off the annular chamber 10 from the outside.

In the cylinder apparatus arranged as stated above, the rod seal 5, which constitutes the double seal 7, is formed from a fluorine-containing resin excellent in sliding performance in view of sliding characteristics. A slight fluid leakage is allowed to occur between the rod seal 5 and the piston rod 2 in response to a rise in fluid pressure in the cylinder 1. Meanwhile, the oil seal 8 is formed from a rubber material excellent in sealing properties. The hydraulic fluid leaking out from between the rod seal 5 and the piston rod 2 is prevented from leaking to the outside by the oil seal 8.

The O-ring 6, which constitutes the double seal 7, is compressively deformed upon receiving the fluid pressure in the cylinder 1 to apply a backup force to the rod seal 5. Accordingly, when the fluid pressure in the cylinder 1 rises in excess of a certain pressure value, the O-ring 6 is strongly compressed against the seal block 4 (seal cap 12) to generate a large backup force, so that the rod seal 5 is pressed against the piston rod 2 with a strong force. As a result, the frictional resistance of the rod seal 5 increases, which impairs smooth extension and contraction (movement) of the piston rod 2 and hence degrades the ride quality. Moreover, the wear of the rod seal 5 is increased, resulting in an increased leakage of hydraulic fluid.

In a cylinder apparatus according to another related art, as shown in FIG. 5, a projection 16 is provided on an end surface of the seal block 4 so as to partially project between the rod seal 5 and the O-ring 6. In this cylinder apparatus, the projection 16 receives a part of the backup force applied from the O-ring 6 to the rod seal 5, thereby preventing the rod seal 5 from being strongly pressed against the piston rod 2. It should be noted that a countermeasure similar to this is also disclosed, for example, in Japanese Laid Open Publication No. 2001-254838.

The above-described countermeasure in which the projection 16 is provided suffers, however, from the following problem. Because the projection 16 is present between the rod seal 5 and the O-ring 6, the backup force from the O-ring 6 is unevenly applied to the rod seal 5, making it likely that the rod seal 5 will tilt (i.e. inclination) and hence will wear unevenly. It should be noted that in the cylinder apparatus disclosed in the above-mentioned Japanese Laid Open Publication No. 2001-254838 a circumferentially extending groove is provided on an end surface of a step portion 5a of the rod seal 5 to reduce the radial rigidity of the step portion 5a, thereby preventing inclination of the rod seal 5. However, the basic structure in which the O-ring is compressively deformed by the fluid pressure to generate a backup force remains unchanged. Therefore, there is a risk that the rod seal 5 will be inclined when an excessive fluid pressure is produced in the cylinder 1.

### SUMMARY OF THE INVENTION

The present invention has been made in view of the above-described problems. An object of the present invention is to provide a cylinder apparatus in which a backup mechanism for pressing a rod seal against a piston rod is arranged to generate a backup force while suppressing the influence of fluid pressure, thereby ensuring smooth movement of the piston rod and suppressing the wear of the rod seal.

To solve the above-described problem, the present invention provides a cylinder apparatus including a cylinder, a piston, a piston rod and a seal device. The cylinder has a hydraulic fluid sealed therein. The piston is slidably fitted in the cylinder. The piston rod is connected at one end thereof to the piston in the cylinder. The other end of the piston rod extends to the outside of the cylinder. The seal device is provided at an opening end of the cylinder. The piston rod extends through the seal device to the outside of the cylinder. The seal device has a rod seal provided in sliding contact with the piston rod. The seal device further has a backup mechanism that presses the rod seal against the piston rod. The backup mechanism has a ring-shaped support plate positioned closer to the cylinder than the rod seal. The backup mechanism further has a ring-shaped resilient member joined to one surface of the ring-shaped support plate and a pressing member that causes elastic deformation of the ring-shaped resilient member to apply a backup force to the rod seal.

According to one aspect of the present invention, the pressing member may be an annular wall provided around said ring-shaped resilient member. The annular wall may be a tapered wall gradually reduced in diameter toward an outer side as viewed in an axial direction of the cylinder.

According to one aspect of the present invention, the seal device may include a seal block having a bore for receiving said piston rod and closing the opening end of the cylinder, which seal block is of a split structure comprising a plurality of divided elements. The rod seal and the backup mechanism may be provided in the seal block. The ring-shaped support plate of the backup mechanism may be clamped between the divided elements of the seal block. In this case, the annular wall may be formed on one of the divided elements of the seal block.

According to one aspect of the present invention, the cylinder apparatus may further comprise a seal member joined to an outer peripheral portion of the one surface of said ring-shaped support plate constituting said backup mechanism. The seal member contacts the seal block to prevent entry of hydraulic fluid to a rear side of the ring-shaped resilient member.

According to one aspect of the present invention, the cylinder may be housed in an outer tube, one end of which is closed, so that an annular chamber is formed between the cylinder and the outer tube. The cylinder apparatus may further comprise a check valve joined to a surface of the ring-shaped support plate opposite to the surface to which the ring-shaped resilient member is joined, which check valve is adapted to allow only flow of hydraulic fluid from the cylinder into the annular chamber.

### BRIEF DESCRIPTION OF THE DRAWINGS

FIG. 1 is a sectional view showing the structure of an main part of a cylinder apparatus according to one embodiment of the present invention.

FIG. 2 is an enlarged sectional view of a seal device of the cylinder apparatus shown in FIG. 1.

FIG. 3 is a sectional view showing the overall structure of the cylinder apparatus arranged as a self-pumping type cylinder apparatus incorporating a self-pumping mechanism.

FIG. 4 is a sectional view showing the structure of an essential part of a cylinder apparatus according to a related art.

FIG. 5 is a sectional view showing a modified structure of a seal device in a cylinder apparatus according to another related art.

### DETAILED DESCRIPTION OF THE PREFERRED EMBODIMENTS

The best mode for carrying out the present invention will be described below with reference to the accompanying drawings.

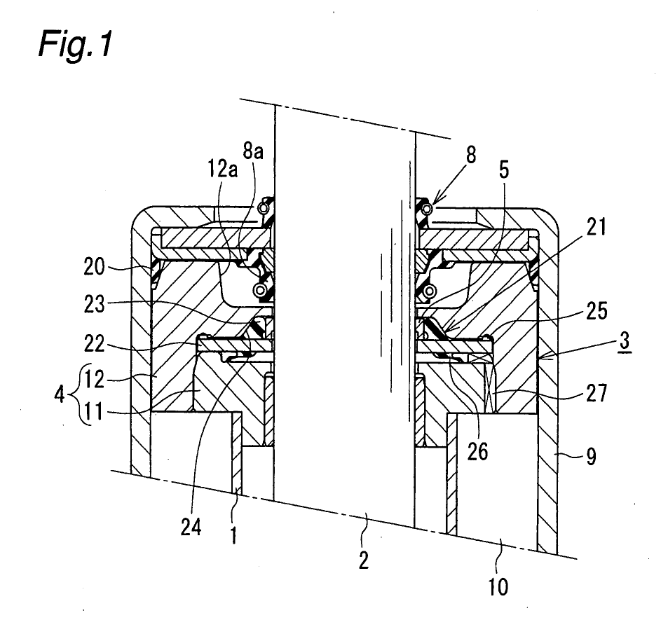

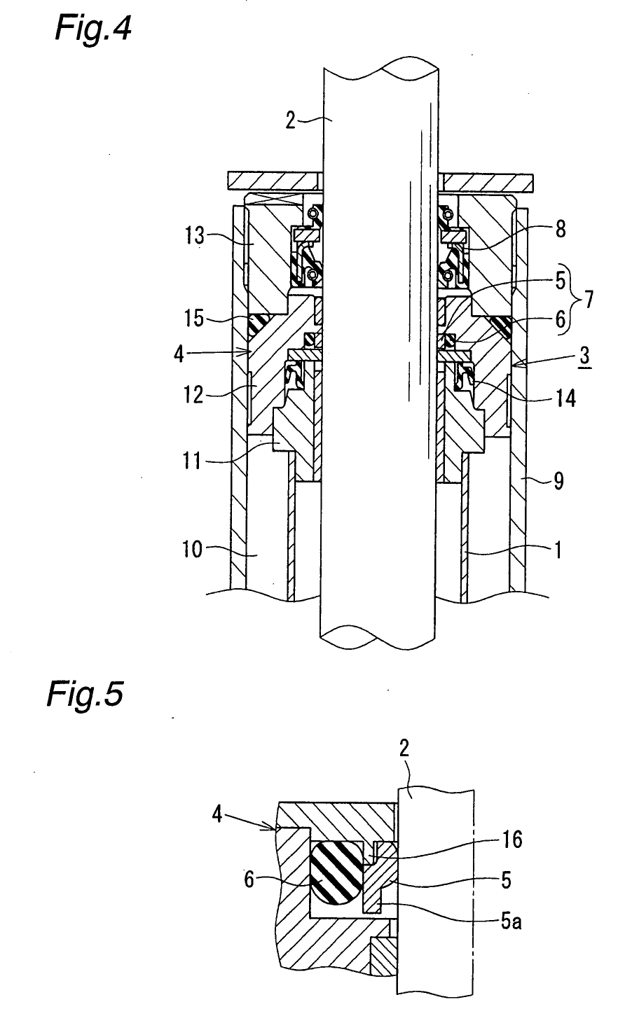

FIGS. 1 to 3 show a cylinder apparatus according to one embodiment of the present invention. The cylinder apparatus is installed in a suspension system of an automobile as a cylinder apparatus for vehicle height control. In this embodiment, the cylinder apparatus is arranged as a self-pumping type cylinder apparatus incorporating a self-pumping mechanism. It should be noted that the basic structure of a seal device 3 in this cylinder apparatus is the same as that shown in the foregoing FIG. 4. Therefore, in this embodiment the same constituent elements as those in FIG. 4 are denoted by the same reference numerals as used in FIG. 4.

In this embodiment, a seal block 4 that constitutes the seal device 3 includes, as shown in FIG. 1, a rod guide 11 that is fitted in a cylinder 1 and slidably guides a piston rod 2. The seal block 4 further includes a seal cap 12 fitted into an outer tube 9 so as to be fitted onto the rod guide 11. In this embodiment, the lock ring 13 (see FIG. 4), which is thread-engaged with the outer tube 9 in the related art, has been omitted from the seal block 4. An oil seal 8 that is provided in sliding contact with the piston rod 2 to prevent leakage of hydraulic fluid to the outside is combined with an outer peripheral seal 20 substituting the seal member 15 (see FIG. 4), which is provided in the related art to cut off the annular chamber 10 from the outside. The oil seal 8 in combination with the outer peripheral seal 20 is disposed on the upper surface of the seal cap 12. It should be noted that the upper surface of the seal cap 12 is provided with a relief recess 12a for receiving a main lip 8a of the oil seal 8. The oil seal 8 and the outer peripheral seal 20 are provided in the form of a subassembly. After having the rod guide 11, the seal cap 12 and the subassembly (oil seal 8 and outer peripheral seal 20) fitted into an opening end portion of the outer tube 9, including an opening end portion of the cylinder 1, the seal device 3 is fixedly staked to the cylinder 1 as one unit by inwardly curling the opening end edge of the outer tube 9.

Meanwhile, a backup mechanism 21 that causes a rod seal 5 slidably contacting the piston rod 2 to be pressed against the piston rod 2 includes a ring-shaped support plate 22 positioned closer to the cylinder 1 than the rod seal 5 and a ring-shaped resilient member 23 joined by baking to one (upper) surface of the ring-shaped support plate 22. The backup mechanism 21 further includes an annular wall (pressing member) 24 that is formed on the inner peripheral side of the seal cap 12. The annular wall 24 causes elastic deformation of the ring-shaped resilient member 23 to apply a backup force to the rod seal 5. The ring-shaped resilient member 23 may be formed from a rubber material, for example. The backup mechanism 21 disuses the O-ring 6 (see FIG. 4), which is employed in the related art.

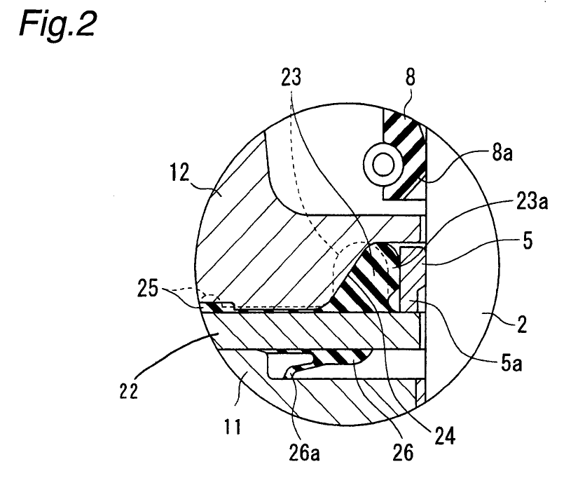

More specifically, the ring-shaped support plate 22, which constitutes the backup mechanism 21, has substantially the same inner and outer diameters as those of the rod guide 11 and is concentrically superimposed over the upper surface of the rod guide 11. The ring-shaped support plate 22 is clamped at an outer peripheral portion thereof between the rod guide 11 and the seal cap 12 fitted thereonto when assembled together. The annular wall 24, which constitutes the backup mechanism 21, is a tapered wall gradually reduced in diameter toward the outer side in the axial direction of the cylinder 1. The ring-shaped resilient member 23 provided on the support plate 22 has a configuration as shown by the dashed line in FIG. 2 before the seal cap 12 is fitted onto the rod guide 11, so that the outer periphery of the ring-shaped resilient member 23 interferes with the annular wall 24 when the seal cap 12 is installed. The ring-shaped resilient member 23 is further configured so that the inner periphery thereof is separate from the outer periphery of the rod seal 5 as shown by the dashed line in FIG. 2 before the seal cap 12 is installed. When the seal cap 12 is fitted onto the rod guide 11 so as to be assembled together, the ring-shaped resilient member 23 is pressed at the rear side thereof by the annular wall (tapered wall) 24 and thus elastically deformed in the diameter decreasing direction. The elastic deformation of the ring-shaped resilient member 23 allows the rod seal 5 to be pressed against the piston rod 2.

In this embodiment, the rod seal 5 has a step portion 5a. That is, only a portion of the rod seal 5 on the outer side thereof in the axial direction of the cylinder 1 (i.e. the upper portion of the rod seal 5 as viewed in FIG. 2) contacts the piston rod 2 as a seal. Therefore, the ring-shaped resilient member 23 also contacts the rod seal 5 only at a contact portion 23a on the outer side thereof in the axial direction of the cylinder 1 (i.e. the upper portion of the ring-shaped resilient member 23 as viewed in FIG. 2).

In this embodiment, a seal member 25 is joined by baking to an outer peripheral portion of the upper surface of the ring-shaped support plate 22 to seal between the support plate 22 and the seal cap 12. The seal member 25 may be formed from a rubber material, for example. The seal member 25 prevents the entry of hydraulic fluid (fluid pressure) to the rear side of the ring-shaped resilient member 23. Thus, the amount of elastic deformation of the ring-shaped resilient member 23 is mechanically determined by engagement with the annular wall 24 substantially independently of the influence of fluid pressure.

In this embodiment, a check valve 26 is joined by baking to the lower surface of the ring-shaped support plate 22. The check valve 26 has a lip portion 26a (see FIG. 2) placed in contact with the upper surface of the rod guide 11. The check valve 26 is adapted to allow only the flow of hydraulic fluid from the cylinder 1 into the annular chamber (reservoir chamber in this embodiment) 10 between the cylinder 1 and the outer tube 9. It should be noted that grooves (hydraulic fluid passages) 27 are formed on the upper and outer peripheral surfaces of the rod guide 11 to smooth the flow of hydraulic fluid from the cylinder 1 into the annular chamber 10.

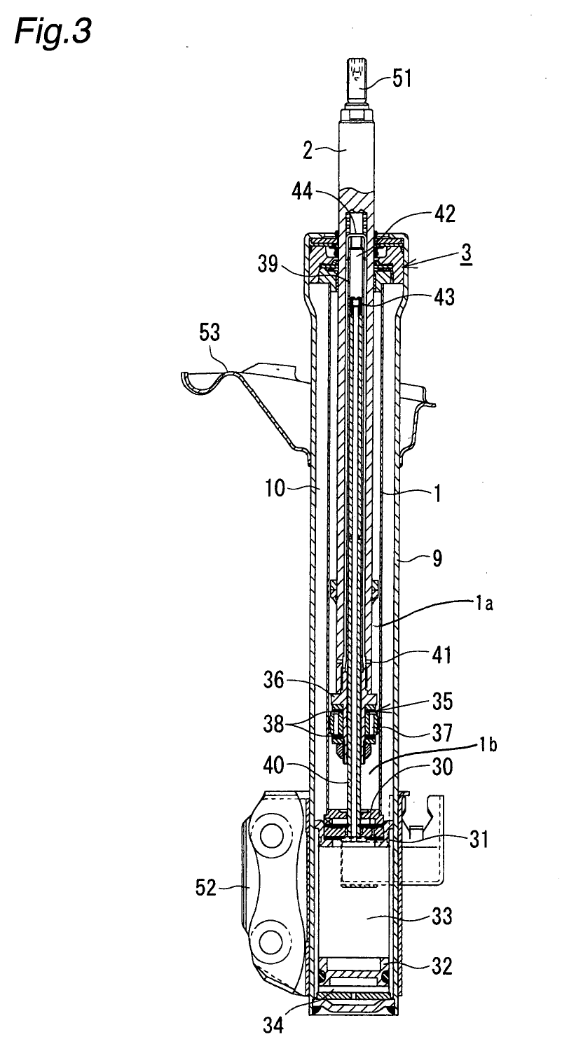

The overall structure of the cylinder apparatus according to this embodiment is as shown in FIG. 3. The interior of the outer tube 9 is divided at a bottom end portion thereof into two chambers, i.e. upper and lower chambers, by a partition member 31 having a base valve 30. The cylinder 1 is provided in the upper chamber of the outer tube 9 divided by the partition member 31, and a free piston 32 is provided in the lower chamber of the outer tube 9. The lower end of the cylinder 1 is butted against the partition member 31 through the base valve 30. The lower chamber is further divided by the free piston 32 into two chambers, i.e. an upper chamber above the free piston 32 and a lower chamber below the free piston 32. The upper chamber serves as a hydraulic fluid chamber (oil tank) 33 having a hydraulic fluid sealed therein. The lower chamber serves as a gas chamber 34 having a high-pressure gas sealed therein.

A ring-shaped piston 35 is slidably fitted in the cylinder 1. The piston 35 divides the interior of the cylinder 1 into two chambers, i.e. a cylinder upper chamber 1a and a cylinder lower chamber 1b. One end portion of the piston rod 2 is connected to the piston 35 through a piston bolt 36. The piston 35 is provided with a plurality of hydraulic fluid passages 37 that communicate between the cylinder upper and lower chambers 1a and 1b. The piston 35 is further provided with disk valves 38 that generate damping forces during the extension and compression strokes, respectively. The piston rod 2 is hollow. A pump tube 39 and a hollow pump rod 40 are concentrically fitted in the hollow inside of the piston rod 2 such that the pump rod 40 extends through the pump tube 39. The lower end of the pump rod 40 extends through the piston 35 as far as the partition member 31. The hollow inside of the pump rod 40 communicates with the oil tank 33. The space between the inner surface of the piston rod 2 and the pump tube 39 is provided as an annular hydraulic fluid passage. The hydraulic fluid passage is communicated with the cylinder upper chamber 1a through a hole 41 provided in the wall of the piston rod 2.

A pump chamber 42 is formed in an upper end portion of the pump tube 39. The upper end of the pump rod 40 is provided with a check valve 43 that allows only the flow of hydraulic fluid from the oil tank 33 into the pump chamber 42 through the hollow inside of the pump rod 40. The upper end of the pump tube 39 is provided with a check valve 44 that allows only the flow of hydraulic fluid from the pump chamber 42 to the hydraulic fluid passage around the pump tube 39. It should be noted that when the length to which the piston rod 2 extends is within a standard range, the pump chamber 42 and the cylinder upper and lower chambers 1a and 1b are kept in communication with each other through a bypass passage (not shown) provided on the pump rod 40. The bypass passage is formed, for example, from a groove provided on the outer periphery of the pump rod 40 to extend axially from the pump chamber 42 to the vicinity of the piston 35. When the extending length of the piston rod 2 exceeds the standard range, the oil tank 33 and the cylinder upper and lower chambers 1a and 1b communicate with each other through a release passage (not shown) provided on the pump rod 40. For example, the release passage is formed from a hole provided on the pump rod 40 below the lower end of the above-described groove to extend diametrically through the center of the pump rod 40.

The cylinder apparatus according to this embodiment is incorporated into a suspension system as shown in FIG. 3. That is, a bolt part 51 provided on the upper end of the piston rod 2 is secured to a vehicle body-side member, and a bracket 52 fixedly provided on the lower end portion of the outer tube 9, one end of which is closed, is secured to a wheel-side member. In this state, a suspension spring (not shown) is retained by a spring retainer 53 secured to an upper end portion of the outer tube 9.

In the cylinder apparatus arranged as stated above, when the vehicle height is a standard vehicle height, the pump chamber 42 and the cylinder upper and lower chambers 1a and 1b are in communication with each other through the bypass passage. Therefore, when the piston rod 2 extends and contracts in response to vibration of the suspension system during running of the vehicle, the cylinder apparatus operates as follows.

During the extension stroke of the piston rod 2, a part of hydraulic fluid in the cylinder upper and lower chambers 1a and 1b flows into the pump chamber 42. During the compression stroke of the piston rod 2, a part of hydraulic fluid in the pump chamber 42 is discharged into the cylinder upper and lower chambers 1a and 1b. Accordingly, there is no change in the vehicle height.

When the vehicle height becomes lower than the standard vehicle height due, for example, to an increase in the carrying load of the vehicle and consequently the extending length of the piston rod 2 becomes less than the standard range, the communication between the pump chamber 42 and the cylinder upper and lower chambers 1a and 1b is cut off. Therefore, when the piston rod 2 extends and contracts in response to vibration of the suspension system during running of the vehicle, the cylinder apparatus operates as follows.

During the extension stroke of the piston rod 2, the pump rod 40 retracts (moves downward in FIG. 3) relative to the pump tube 39, resulting in a reduction in the pressure in the pump chamber 42. Consequently, the check valve 43 opens to allow the hydraulic fluid in the oil tank 33 to be introduced into the pump chamber 42 through the passage in the pump rod 40. During the compression stroke of the piston rod 2, the pump rod 40 advances (moves upward in FIG. 3) relative to the pump tube 39, causing the pump chamber 42 to be pressurized. Consequently, the check valve 44 opens to allow the hydraulic fluid in the pump chamber 42 to be supplied into the cylinder upper chamber 1a through the hydraulic fluid passage around the pump tube 39 and the hole 41 of the piston rod 2. The hydraulic fluid is further supplied into the cylinder lower chamber 1b through the hydraulic fluid passages 37. Accordingly, the piston rod 2 is extended. In this way, the pumping operation is repeated by using vibration during running of the vehicle, thereby allowing the vehicle height to rise. When the vehicle height reaches the standard vehicle height, the pump chamber 42 is communicated with the cylinder upper and lower chambers 1a and 1b, and the pumping operation is canceled.

When the vehicle height becomes higher than the standard vehicle height due, for example, to a decrease in the carrying load of the vehicle and consequently the extending length of the piston rod 2 exceeds the standard range, the pump chamber 42 is communicated with the cylinder upper and lower chambers 1a and 1b through the bypass passage, and the pumping operation is canceled. In addition, the cylinder upper and lower chambers 1a and 1b are communicated with the hollow inside of the pump rod 40 through the release passage. Consequently, the hydraulic fluid in the cylinder upper and lower chambers 1a and 1b is returned to the oil tank 33, resulting in a decrease in the volume of hydraulic fluid in the cylinder upper and lower chambers 1a and 1b and the annular chamber (reservoir chamber) 10. Accordingly, the vehicle height lowers. When the vehicle height lowers to the standard vehicle height and consequently the extending length of the piston rod 2 falls within the standard range, the hydraulic fluid returning operation is stopped.

Thus, the vehicle height can be adjusted to a constant level independently of the carrying load and so forth by repeating the pumping operation and the hydraulic fluid returning operation utilizing vibration of the suspension system during running of the vehicle. It should be noted that when the piston rod 2 extends and contracts, the disk valves 38, which are provided on the piston 35, open and close to generate predetermined damping forces.

When the pressure of hydraulic fluid in the cylinder 1 (cylinder upper chamber 1a) rises in response to the extension and contraction of the piston rod 2, the fluid pressure may also act on the backup mechanism 21 in the seal device 3. In this regard, the ring-shaped resilient member 23, which presses the rod seal 5 against the piston rod 2, is surrounded by the ring-shaped support plate 22, which is clamped between the rod guide 11 and the seal cap 12, and the annular wall (tapered wall) 24 at the rear of the ring-shaped resilient member 23. Therefore, the fluid pressure does not act on the ring-shaped resilient member 23. Accordingly, the backup force applied to the rod seal 5 from the ring-shaped resilient member 23 is kept substantially constant independently of the influence of fluid pressure. As a result, there is no likelihood that the frictional resistance of the rod seal 5 will increase. Thus, smooth extension and contraction (movement) of the piston rod 2 can be ensured, and the wear of the rod seal 5 itself can be suppressed. Particularly, in this embodiment, the seal member 25 provided on the outer peripheral portion of the ring-shaped support plate 22 surely blocks the entry of hydraulic fluid (fluid pressure) to the rear side of the ring-shaped resilient member 23. Therefore, the backup force is kept very stable, so that the extension and contraction movement of the piston rod 2 becomes even smoother. In addition, because the ring-shaped resilient member 23 applies pressure uniformly to the rod seal 5 while being in contact with the back of the rod seal 5, inclination of the rod seal 5 no longer occurs. As a result, uneven wear of the rod seal 5 is also suppressed.

In this embodiment, the ring-shaped support plate 22, which constitutes the backup mechanism 21, is integrally provided with the check valve 26 that allows only the flow of hydraulic fluid from the cylinder 1 into the annular chamber 10 around the cylinder 1. Therefore, it is possible to reduce the number of constituent parts in comparison to the cylinder apparatus according to the related art in which the check valve 14 (FIG. 4) is provided separately, and hence possible to improve the assembleability of the cylinder apparatus. In addition, the oil seal 8 is combined with the outer peripheral seal 20 so as to be incorporated as a subassembly, and the subassembly and the seal block 4 are fixedly staked to the cylinder 1 by curling the opening end edge of the outer tube 9. Therefore, it is possible to reduce the number of components to be assembled and the number of constituent parts in comparison to the cylinder apparatus according to the related art that requires the seal member 15 and the lock ring 13 (FIG. 4) separately. In this regard also, the assembleability of the cylinder apparatus is improved.

Although in the foregoing embodiment the cylinder apparatus is constructed as a vehicle height control cylinder apparatus incorporating a self-pumping mechanism, the present invention is applicable to any type of vehicle height control system. The vehicle height control cylinder apparatus may be arranged such that a hydraulic fluid supply and discharge mechanism and a damping force generating mechanism are provided outside a cylinder as disclosed in the aforementioned Japanese Laid Open Publication No. 2001-254838. In addition, the application range of the present invention is not limited to the above-described vehicle height control cylinder apparatus. The present invention is also applicable to various cylinder apparatus that require a rod seal and a backup mechanism therefor as a seal device, for example, hydraulic cylinders and hydraulic shock absorbers.

Further, although in the foregoing embodiment the ring-shaped resilient member 23 is shown to be a perfect ring-shaped member, by way of example, the configuration of the ring-shaped resilient member 23 is not necessarily limited to the described shape. The ring-shaped resilient member 23 may be of a partially discontinuous ring shape. However, in case that a partially discontinuous ring-shaped resilient member 23 is employed, an extra seal member needs to be provided at a side of the rod seal 5 closer to the cylinder 1.

In the cylinder apparatus according to the foregoing embodiment, the ring-shaped resilient member 23 is joined to the ring-shaped support plate 22, and this ring-shaped resilient member 23 is elastically deformed by the pressing member 24 to generate a backup force. Therefore, the backup force is determined by the amount of elastic deformation of the ring-shaped resilient member 23 caused by the pressing member 24. Accordingly, the force with which the rod seal 5 is pressed against the piston rod 2 is kept substantially constant independently of the change in fluid pressure in the cylinder 1. Consequently, there is no likelihood that the frictional resistance of the rod seal 5 will increase excessively. Thus, smooth extension and contraction movement of the piston rod 2 is ensured, and the wear of the rod seal 5 is suppressed. Further, because it is unnecessary to interpose an extra member between the rod seal 5 and the backup mechanism 21, the backup force can be applied uniformly to the rod seal 5. Accordingly, the inclination of the rod seal 5 is suppressed, and the uneven wear of the rod seal 5 is also suppressed.

In the cylinder apparatus according to the foregoing embodiment, the backup mechanism 21 that presses the rod seal 5 against the piston rod 2 is arranged to generate a backup force while suppressing the influence of fluid pressure. Therefore, the force with which the rod seal 5 is pressed against the piston rod 2 is kept substantially constant. Accordingly, it becomes possible to ensure smooth movement of the piston rod 2, and the wear of the rod seal 5, including uneven wear thereof, is suppressed.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2006-296844, filed on Sep. 30, 2006. The entire disclosure of Japanese Patent Application No. 2006-296844 filed on Sep. 30, 2006, including specification, claims, drawings and summary is incorporated herein by reference in its entirety.

The Japanese Laid Open Publication No. 2001-254838 is incorporated herein by reference in its entirety.

What is claimed is:

1. A cylinder apparatus comprising:
a cylinder having a hydraulic fluid sealed therein;
a piston slidably fitted in said cylinder;
a piston rod connected at one end thereof to said piston in said cylinder, the other end of said piston rod extending to an outside of said cylinder; and
a seal device provided at an opening end of said cylinder, said piston rod extending through said seal device to the outside of said cylinder;
said seal device having:
a rod seal provided in sliding contact with said piston rod; and
a backup mechanism that presses said rod seal against said piston rod;
said backup mechanism having:
a ring-shaped support plate positioned closer to said cylinder than said rod seal;
a ring-shaped resilient member joined to one surface of said ring-shaped support plate; and
a pressing member that causes elastic deformation of said ring-shaped resilient member to apply a backup force to said rod seal.

2. The cylinder apparatus of claim 1, wherein said pressing member is an annular wall provided around said ring-shaped resilient member, said annular wall being a tapered wall gradually reduced in diameter toward an outer side as viewed in an axial direction of said cylinder.

3. The cylinder apparatus of claim 1, wherein said seal device includes a seal block having a bore for receiving said piston rod and closing the opening end of said cylinder, said seal block being of a split structure comprising a plurality of divided elements;
said rod seal and said backup mechanism being provided in said seal block;
said ring-shaped support plate of said backup mechanism being clamped between said divided elements of said seal block.

4. The cylinder apparatus of claim 2, wherein said seal device includes a seal block having a bore for receiving said piston rod and closing the opening end of said cylinder, said seal block being of a split structure comprising a plurality of divided elements;
said rod seal and said backup mechanism being provided in said seal block;
said ring-shaped support plate of said backup mechanism being clamped between said divided elements of said seal block.

5. The cylinder apparatus of claim 3, wherein said pressing member is formed on one of said divided elements of said seal block.

6. The cylinder apparatus of claim 4, wherein said annular wall is formed on one of said divided elements of said seal block.

7. The cylinder apparatus of claim 3, further comprising:
a seal member joined to an outer peripheral portion of the one surface of said ring-shaped support plate constituting said backup mechanism, said seal member contacting said seal block to prevent entry of hydraulic fluid to a rear side of said ring-shaped resilient member.

8. The cylinder apparatus of claim 4, further comprising:
a seal member joined to an outer peripheral portion of the one surface of said ring-shaped support plate constituting said backup mechanism, said seal member contacting said seal block to prevent entry of hydraulic fluid to a rear side of said ring-shaped resilient member.

9. The cylinder apparatus of claim 5, further comprising:
a seal member joined to an outer peripheral portion of the one surface of said ring-shaped support plate constituting said backup mechanism, said seal member contacting said seal block to prevent entry of hydraulic fluid to a rear side of said ring-shaped resilient member.

10. The cylinder apparatus of claim 6, further comprising:
a seal member joined to an outer peripheral portion of the one surface of said ring-shaped support plate constituting said backup mechanism, said seal member contacting said seal block to prevent entry of hydraulic fluid to a rear side of said ring-shaped resilient member.

11. The cylinder apparatus of claim 1, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

12. The cylinder apparatus of claim 2, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

13. The cylinder apparatus of claim 3, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

14. The cylinder apparatus of claim 4, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

15. The cylinder apparatus of claim 5, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

16. The cylinder apparatus of claim 6, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

17. The cylinder apparatus of claim 7, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

18. The cylinder apparatus of claim 8, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

19. The cylinder apparatus of claim 9, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.

20. The cylinder apparatus of claim 10, wherein said cylinder is housed in an outer tube, one end of which is closed, so that an annular chamber is formed between said cylinder and said outer tube;
said cylinder apparatus further comprising:
a check valve joined to a surface of said ring-shaped support plate opposite to the surface to which said ring-shaped resilient member is joined, said check valve being adapted to allow only flow of hydraulic fluid from said cylinder into said annular chamber.
